(19) United States
(12) Patent Application Publication
(10) Pub. No.: US 2020/0306619 A1
(43) Pub. Date: Oct. 1, 2020

(54) FLAG FUSION

(71) Applicant: Susannah Lawrence, Brookline, MA (US)

(72) Inventor: Susannah Lawrence, Brookline, MA (US)

(21) Appl. No.: 16/831,969

(22) Filed: Mar. 27, 2020

Related U.S. Application Data
(60) Provisional application No. 62/824,477, filed on Mar. 27, 2019.

(51) Int. Cl. A63F 3/04

(52) U.S. Cl. CPC A63F 3/0434; A63F 13/00; A63F 2003/0436

(57) ABSTRACT

A kit of parts for playing a game is described. The parts include a background part, or a base, and components representing the visual design elements of flags of various nations. The game involves creating an original flag by attaching one or more of the components representing the visual design elements of flags to the background. Rules for playing the game are described. The game can be played by individuals, or in groups.

### CROSS-REFERENCE TO RELATED APPLICATIONS

This application claims priority to and the benefit of co-pending U.S. provisional patent application Ser. No. 62/824,477, filed Mar. 27, 2019, which application is incorporated herein by reference in its entirety.

### STATEMENT REGARDING FEDERALLY FUNDED RESEARCH OR DEVELOPMENT

Not Applicable.

### THE NAMES OF THE PARTIES TO A JOINT RESEARCH AGREEMENT

Not Applicable.

### INCORPORATION-BY-REFERENCE OF MATERIAL SUBMITTED ON A COMPACT DISC

Not Applicable.

### FIELD OF THE INVENTION

The invention relates to games in general and particularly to a game and its embodiment in kit form.

### BACKGROUND OF THE INVENTION

Humans have entertained themselves and have engaged in learning by playing games for many years. Many kinds of games are known, including games that employ articles such as playing cards, game boards and game pieces. Some games are limited by specific rules that only allow specific acts, such as moving a piece according to defined rules on a board (as in chess, checkers, or Go). Some games allow a player to provide original input, such as the game “Dictionary” in which players create and write down their definitions of a word read from a dictionary by one of the players.

There is a need for games in which the creativity of players is limited only by their imagination.

### SUMMARY OF THE INVENTION

According to one aspect, the invention features a kit for playing a game, comprising a flag-proportioned base upon which one or more visual elements may be disposed; at least one visual element comprising a portion of a flag; and a set of rules for playing the game.

In one embodiment, the at least one visual element is provided on a substrate.

In another embodiment, the kit for playing a game further comprises a substance configured to allow the at least one visual element to be affixed to the flag-proportioned base.

In yet another embodiment, the at least one visual element is provided in digital form suitable for use in a general purpose programmable computer.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 through FIG. 32 illustrate by way of example some of the elements that can be provided for use in the Flag Fusion game, and show some examples of flags made using the principles of the invention.

FIG. 33 is a diagram illustrating a general purpose programmable computer upon which the game according to principles of the invention may be played by a participant. The general purpose programmable computer may be operated while under the control of a set of instructions recorded on a machine readable medium in a nonvolatile manner with input from the participant.

FIG. 34 is a flow diagram illustrating the method of playing the Flag Fusion game that is carried out with the general purpose programmable computer of FIG. 33.

### DETAILED DESCRIPTION

Flag Fusion is a game including a technique by which players can create their own flag collage by rearranging and combining genuine flag parts to create an original flag of their own. The game is based on visual elements found in one or more of the 197 national flags (at the present time) that are extant in the world. In the future, should the number of national flags change, elements can be added or omitted as required.

According to one aspect, the invention features a kit for playing a game, comprising: a flag-proportioned base (which may also be described as a background) upon which one or more visual elements (which may also be described as visual design elements) may be disposed; at least one visual element comprising a portion of a flag; and a set of rules for playing said game.

As used herein, the term “flag part” or “Flag Part” in the singular or the plural is intended to denote any of the flag-proportioned base and/or any of the visual design elements.

In one embodiment, the kit for playing a game further comprising a substance configured to allow said at least one visual element to be affixed to said flag-proportioned base.

In one embodiment, the game elements can be packaged as a kit. The kit can be made to scale for (1) a family, or (2) an educational activity for any of: (a) a classroom, (b) a school, or (c) an institution, such as an educational event, a business event, or an international conference. The game is preferably played by at least two individual player, or two teams of players, also referred to as participants.

The game can be used as any one or more of: a team-building activity, art therapy, an icebreaker game, or a. tool for communication.

The game can be made-to-order in any quantity or scale.

In some embodiments, when used as a tool for communication, a key listing all the meanings of the individual Flag Parts that are in the kit can be provided that describes the meaning of each element in order to aid participants in creating their own personal meanings or values through the combination of elements they select.

The rules for playing Flag Fusion can include one or more objectives to be attained, for example:

(1) for participants to write descriptions of the flags that the participants sampled visual elements from and explaining why they chose and patterned the visual elements, for example by supplying either personal or aesthetic reasons;

(2) for participants to name their new Flag Fusions;

(3) for participants to explain what they hope this new Flag Fusion might represent, or, perhaps, call into question.

The rules may include some or all of objectives (1), (2) and (3), and may include other objectives, such as being first to complete the objectives defined for that instance of playing the game. In some embodiments, that various objectives may be given individual “weights” so that a “score” for each participant may be computed by computing a product of an objective weight multiplied by a value (such as a range from 0 to 10 indicative of how well the participant attained that objective) and summing all such products over all objectives.

In some embodiments, a “judge” or “referee” may be empowered to determine a “winner.” The “judge” or “referee” is a human person who organizes the instance of playing the game, but who does not participate as a player of the game. In a preferred embodiment, the “judge” or “referee” is required to announce reasons why the “winner” was selected. In another embodiment, the “judge” or “referee” may announce multiple “winners” in different categories.

In one embodiment, each participant is required to create a personal flag by selecting appropriate visual elements created as cutout elements from among the flags of different nations in order to constitute an original flag design, incorporating whatever might be the symbolic meaning of their arrangement of flag parts or their desired aesthetic design, or both aspects.

In one embodiment of playing the game, each participant receives a flag-proportioned base (e.g., a 3:5 ratio paper or card.) upon which the participant may affix (for example, glue or paste) an array of visual elements, such as color cut-out paper prints of images proportioned to the base and chosen from all the national flags (e.g., the vertical and horizontal flag colored stripes, stars, crests, symbols, etc. taken from all 197 national flags). As used herein, the term “substrate” is used to denote any material, such as paper, cardboard or plastic sheet, upon which the visual elements and/or the flag proportioned base are provided, such as for example visual elements in printed form. In another embodiment, the flag may be completed without affixing or gluing the visual elements to the base, but may be completed by photographing or otherwise recording an image of the visual elements and the base when assembled in the final configuration. By selecting from these cut-out elements of flags, participants may design personalized flags as they mix distinctive elements proper to the different nations, collaging them together like a puzzle or overlapping. Once they have created original designs using these symbols, in some embodiments they attach them to the flag-shaped base with a substance such as an adhesive, for example glue. In other embodiments, the adhesive can be transparent tape, double sided tape, mucilage, or other commonly used adhesive products.

In some embodiments, the kit may be electronic in nature and the game may be played on a device controlled by a general purpose programmable computer having a display capability provided by a screen, a printer, or a projector that can project an image on a surface external to the general purpose programmable computer.

In some embodiments, the Flag Fusion kit can include a description, such as in a booklet or a computer-readable file recorded in a non-volatile memory, containing a key to the flag elements corresponding to all the national flags, a breakdown of all their individual components, complete with a description of the significance of the symbolism of each flag element, which could also include and the story of each nation's flag design. In some embodiments, the meanings may also be printed on the backs of each of the individual Flag Fusion elements for quick and easy reference.

In some embodiments, a Flag Fusion kit can include strings or ribbons so that participants can create a flag-bunting banner, and/or it can include rods or sticks that can be used to simulate a flagpole for a flag.

In some embodiments, a Flag Fusion kit can be customized. In some embodiments the flag elements can be provided in different sizes. It is expected that, if a gathering should have a plurality of participants from the same country, additional bases, along with specific or additional national elements, can also be provided.

The Flag Fusion “make your own flag” project is expected to be marketable as an activity kit for various purposes such intemational-themed parties, team-building, icebreakers, an educational game for schools or families, used as bunting or to create group or personal messages through the imagery based on a list of the meanings of all the individual Flag elements.

In some embodiments, Flag Fusion kits can be made available on any scale provided that the elements are correctly proportioned to the base. In some embodiments, the base is provided in proportions (length and width) such as ratios of 1:2, 3:5, 2:3 or in accord with the official or accepted flag ratios and shape of a given flag as may exist at the time of its being represented.

In some embodiments, the elements for Flag Fusion designs can include flags of nations/countries, provinces, states, regions, cities, maritime, diplomatic, sports leagues, tribes, or any other sort of group, as well as past and present flags.

In some embodiments, the Flag Fusion visual parts can be constructed from virtually any material: e.g., colored paper, embossed prints, digital ink-jet print, vinyl, fabric, felt, magnet-backed material, sticker paper, plastic, rubber, wood, glass, ceramic, metal, plexiglass, gels, etc. The flag components and base can be opaque or transparent as with stained glass.

In some embodiments, there can be provided a sealed or sewn fold or other structure on the right, upper or left edge to allow a user to string flags together to create a sleeve, or insert a pole or post through for display.

In some embodiments, Flag Fusion could be used as game, an art activity, an educational project, a team building workshop, a sociological project, or an icebreaker activity.

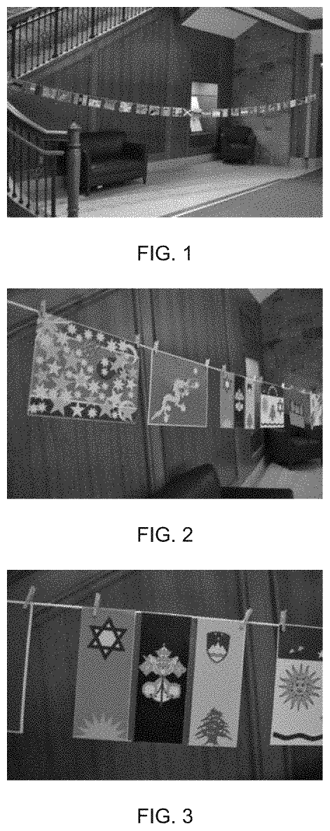

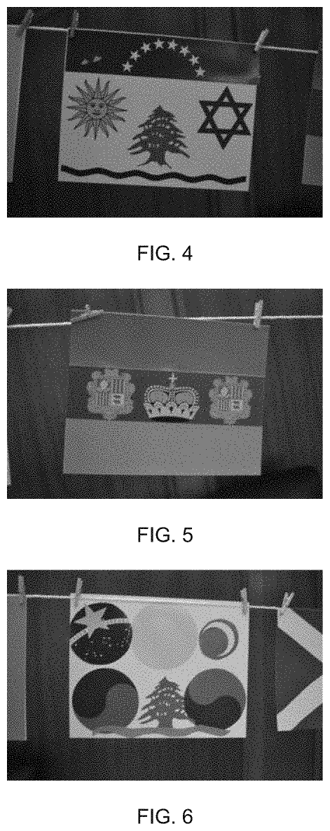

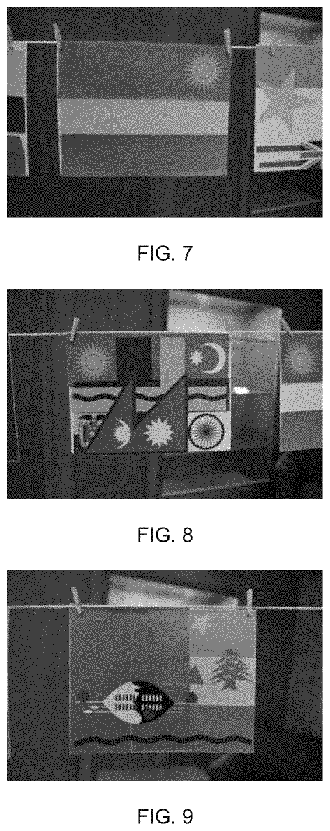

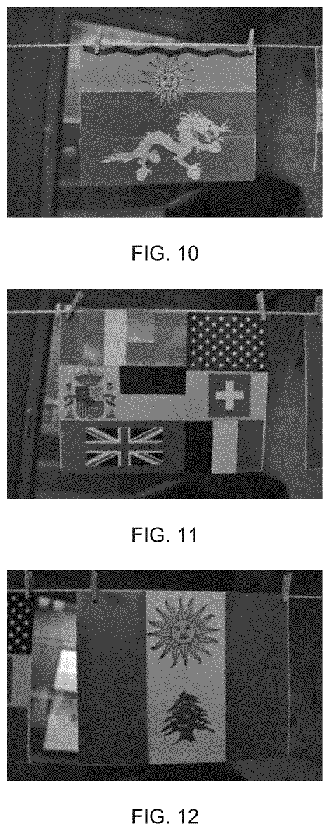

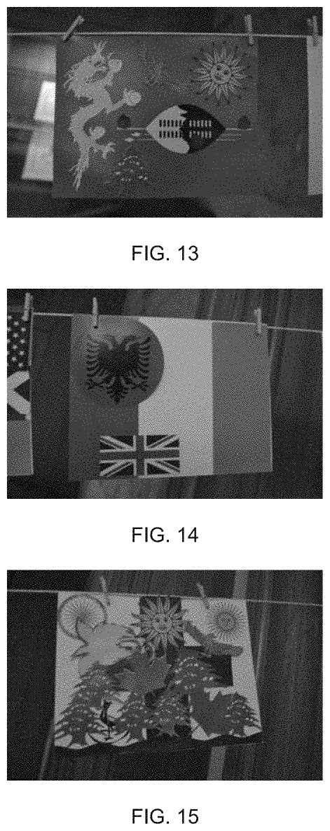

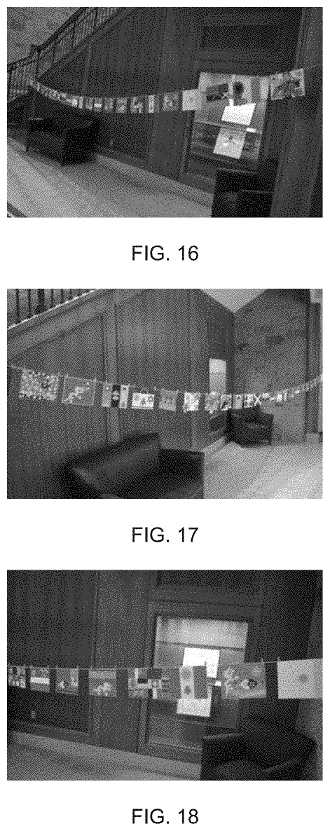

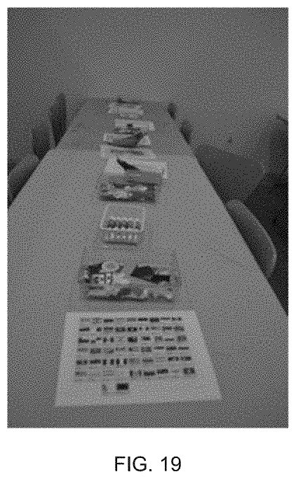

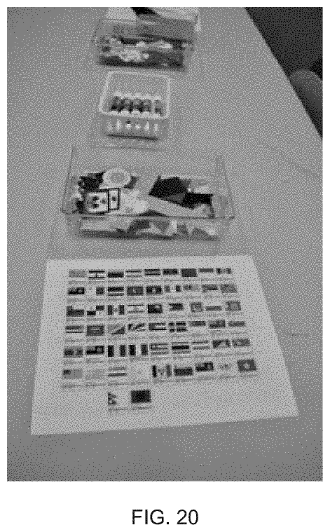

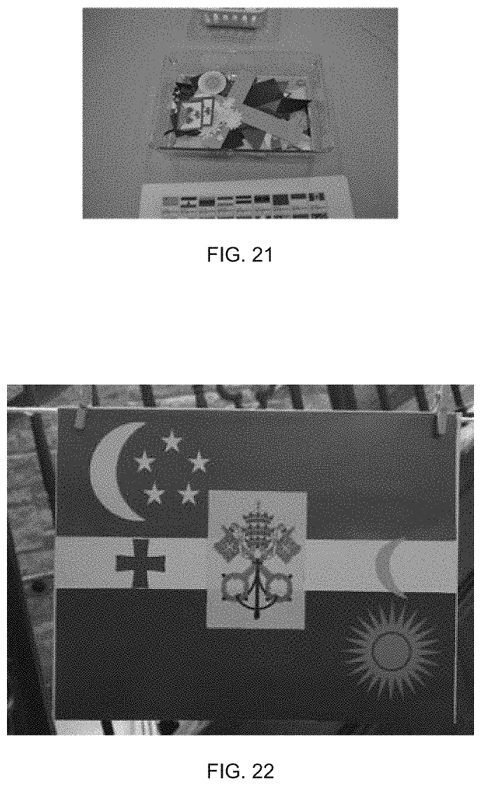

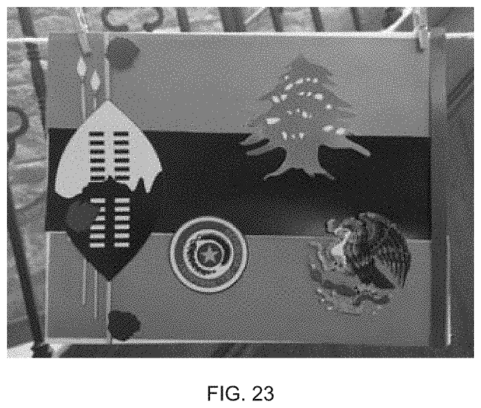

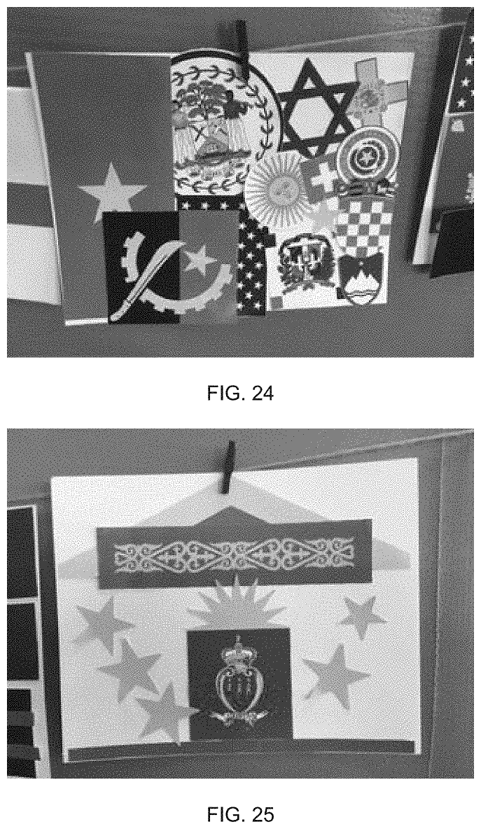

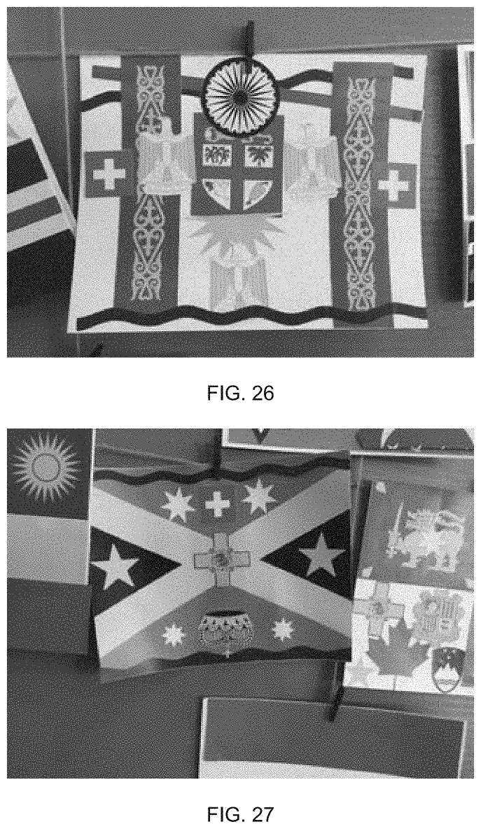

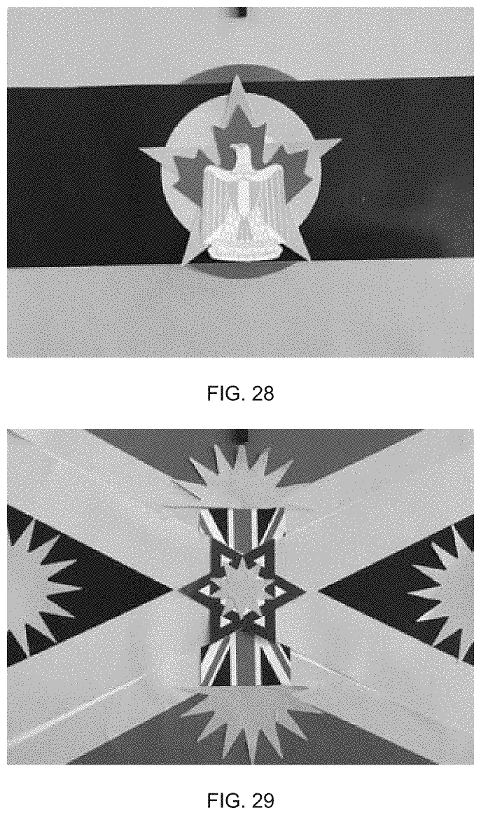

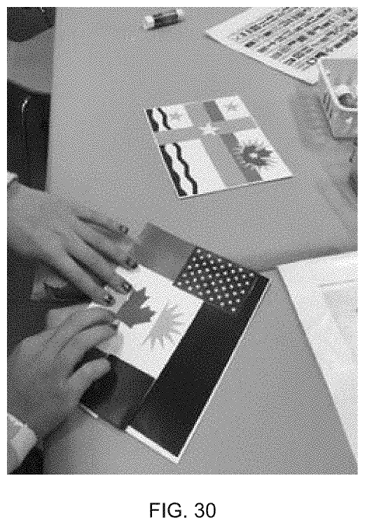

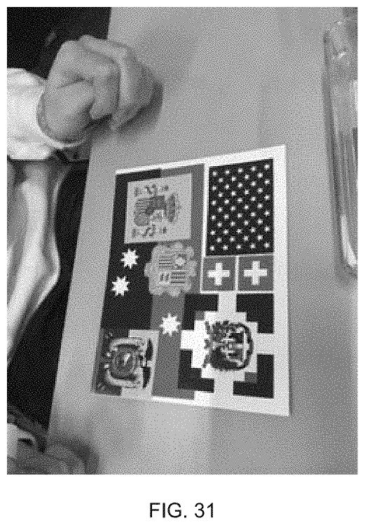

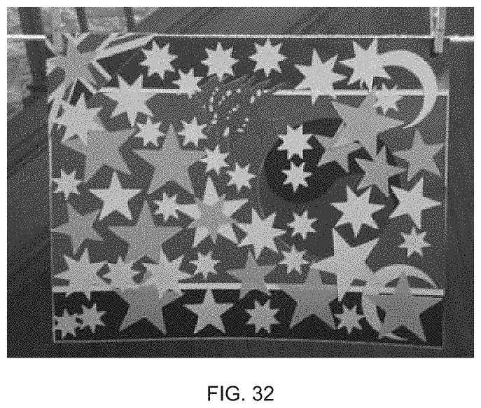

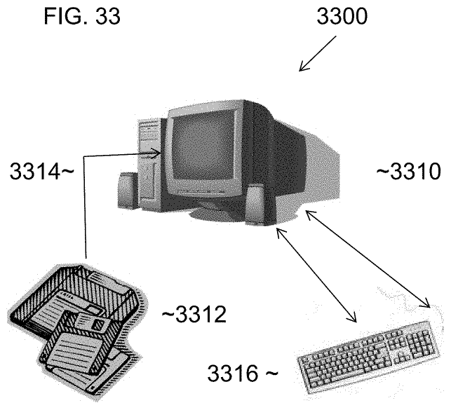

FIG. 1 through FIG. 32 illustrate by way of example some of the elements that can be provided for use in the Flag Fusion game, and show some examples of flags made using the principles of the invention. While the images shown in FIG. 1 through FIG. 32 are presented in black and white, it should be understood that visual design elements may include color visual design elements as well as black and white or grey scale visual design elements. For example, in FIG. 11, shown in blak and white, there are elements of the American flag, (e.g., the blue field with white stars) and the British flag (the “Union Jack”) which are well known to have red, white and blue portions or elements.

FIG. 33 is a diagram 3300 illustrating a general purpose programmable computer upon which the game according to principles of the invention may be played by a participant. The general purpose programmable computer may be operated while under the control of a set of instructions recorded on a machine readable medium in a nonvolatile manner with input from the participant.

In FIG. 33, a general purpose programmable computer 3310 is provided with a set of instructions (a calculation model) that, when operating on the general purpose programmable computer 3310, perform a calculation of an expected water distribution within an uncured porous concrete product. The set of instructions is recorded on a non-volatile machine readable medium 3312, such as a floppy disk, that can be in communication (via arrow 3314) with the general purpose programmable computer 3310. The general purpose programmable computer 3310 is in bidirectional communication (see arrows) with a pointing apparatus 3318 such as a mouse and with an input apparatus 3316 such as a keyboard. The participant using the computer can provide instructions by way of pointing apparatus 3318 and input apparatus 3316, alone or in combination.

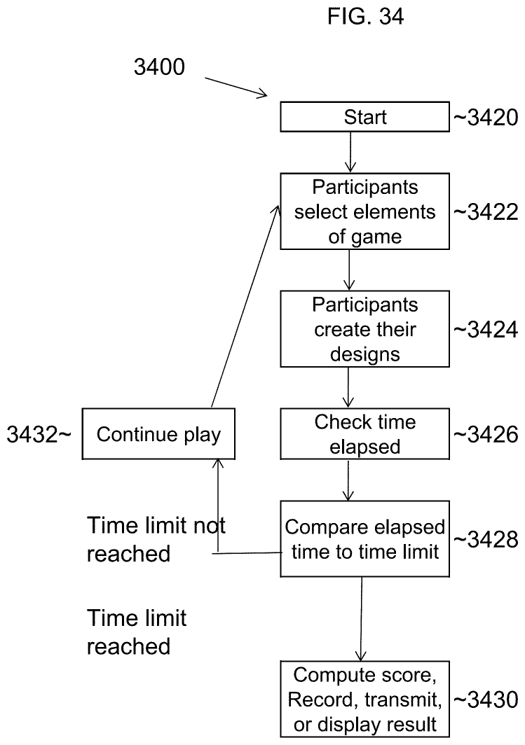

FIG. 34 is a flow diagram illustrating the method of playing the Flag Fusion game that is carried out with the general purpose programmable computer of FIG. 33.

In FIG. 34, at step 3420 the process performs starts, a timer is set to zero (0) time, and a length of time for play (the duration of the game) is defined and announced to the participants. By way of example, a duration of 15 minutes or 30 minutes might be defined as the length of time for play. This duration may be determined by prearranged rule, by a referee, or by the agreement of the participants.

At step 3422 a participant selects the elements of the game that the participant wishes to use, such as one or more flag components, one or more components that the participant wish to design for him- or herself, and a background that the participant will use. The components can be images used in computers, such as jpg or gif files, or can be paper visual objects as shown in FIG. 1 through FIG. 32.

At step 3424 the participant creates his or her design. In a computer based game, the participant may use a commercially available program such as, by way of example, Microsoft PowerPoint, PhotoShop or LibreOffice Impress in order to manipulate images. A paper based game has been described hereinabove.

At step 3426 the time is checked. This is readily done in a computer, where a process computes the elapsed time. It can also be done by having a referee check a timepiece, or by setting a mechanical timer such as a count-down oven timer that emits a signal (such as an audible ring) when the timer counts down to zero.

At step 3428 the process compares the elapsed time since the start of the game to the predefined duration of the game. In the event that the predefined time for play or game duration, has not elapsed, the process performs step 3432 so as to repeat steps 3422, 3424, 3426, and 3438 until the elapsed time equals the predefined duration of the game. This is readily done in a computer based game by allowing steps 2422, 3424, 3436 and 3428 to be repeatedly and iteratively performed.

In a computer based game, there may be visual or auditory signals provided to a participant indicating the remaining time of the game. In a paper based game4, the referee may periodically announce how much time remains in the game. A participant may also consult a personal timepiece to determine (at least approximately) how much time remains in the game.

In the event that the elapsed time of the game is reached, as illustrated at step 3430, the game ends, and the score of a participant is computed. In a computer based game, the result (the score) is recorded, is transmitted to a referee and/or a participant, and/or may be displayed for viewing. Examples of displaying an image for viewing are also presented in U.S. Pat. No. 7,097,307 and U.S. Pat. No. 7,144,114.

### Definitions

Any reference in the claims to an electronic signal or an electromagnetic signal (or their equivalents) is to be understood that in a preferred embodiment the signal is a non-transitory electronic signal or a non-transitory electromagnetic signal. If the signal per se is not claimed, the reference may in some instances be to a description of a propagating or transitory electronic signal or electromagnetic signal.

Recording the results from an operation or data acquisition, such as for example, recording results at a particular frequency or wavelength, is understood to mean and is defined herein as writing output data in a non-transitory manner to a storage element, to a machine-readable storage medium, or to a storage device. Non-transitory machine-readable storage media that can be used in the invention include electronic, magnetic and/or optical storage media, such as magnetic floppy disks and hard disks; a DVD drive, a CD drive that in some embodiments can employ DVD disks, any of CD-ROM disks (i.e., read-only optical storage disks), CD-R disks (i.e., write-once, read-many optical storage disks), and CD-RW disks (i.e., rewriteable optical storage disks); and electronic storage media, such as RAM, ROM, EPROM, Compact Flash cards, PCMCIA cards, or alternatively SD or SDIO memory; and the electronic components (e.g., floppy disk drive, DVD drive, CD/CD-R/CD-RW drive, or Compact Flash/PCMCIA/SD adapter) that accommodate and read from and/or write to the storage media. Unless otherwise explicitly recited, any reference herein to “record” or “recording” is understood to refer to a non-transitory record or a non-transitory recording.

As is known to those of skill in the machine-readable storage media arts, new media and formats for data storage are continually being devised, and any convenient, commercially available storage medium and corresponding read/write device that may become available in the future is likely to be appropriate for use, especially if it provides any of a greater storage capacity, a higher access speed, a smaller size, and a lower cost per bit of stored information. Well known older machine-readable media are also available for use under certain conditions, such as punched paper tape or cards, magnetic recording on tape or wire, optical or magnetic reading of printed characters (e.g., OCR and magnetically encoded symbols) and machine-readable symbols such as one and two dimensional bar codes. Recording image data for later use (e.g., writing an image to memory or to digital memory) can be performed to enable the use of the recorded information as output, as data for display to a user, or as data to be made available for later use. Such digital memory elements or chips can be standalone memory devices, or can be incorporated within a device of interest. “Writing output data” or “writing an image to memory” is defined herein as including writing transformed data to registers within a microcomputer.

“Microcomputer” is defined herein as synonymous with microprocessor, microcontroller, and digital signal processor (“DSP”). It is understood that memory used by the microcomputer, including for example instructions for data processing coded as “firmware” can reside in memory physically inside of a microcomputer chip or in memory external to the microcomputer or in a combination of internal and external memory. Similarly, analog signals can be digitized by a standalone analog to digital converter (“ADC”) or one or more ADCs or multiplexed ADC channels can reside within a microcomputer package. It is also understood that field programmable array (“FPGA”) chips or application specific integrated circuits (“ASIC”) chips can perform microcomputer functions, either in hardware logic, software emulation of a microcomputer, or by a combination of the two. Apparatus having any of the inventive features described herein can operate entirely on one microcomputer or can include more than one microcomputer.

General purpose programmable computers useful for controlling instrumentation, recording signals and analyzing signals or data according to the present description can be any of a personal computer (PC), a microprocessor based computer, a portable computer, or other type of processing device. The general purpose programmable computer typically comprises a central processing unit, a storage or memory unit that can record and read information and programs using machine-readable storage media, a communication terminal such as a wired communication device or a wireless communication device, an output device such as a display terminal, and an input device such as a keyboard. The display terminal can be a touch screen display, in which case it can function as both a display device and an input device. Different and/or additional input devices can be present such as a pointing device, such as a mouse or a joystick, and different or additional output devices can be present such as an enunciator, for example a speaker, a second display, or a printer. The computer can run any one of a variety of operating systems, such as for example, any one of several versions of Windows, or of MacOS, or of UNIX, or of Linux. Computational results obtained in the operation of the general purpose programmable computer can be stored for later use, and/or can be displayed to a user. At the very least, each microprocessor-based general purpose programmable computer has registers that store the results of each computational step within the microprocessor, which results are then commonly stored in cache memory for later use, so that the result can be displayed, recorded to a non-volatile memory, or used in further data processing or analysis.

Many functions of electrical and electronic apparatus can be implemented in hardware (for example, hard-wired logic), in software (for example, logic encoded in a program operating on a general purpose processor), and in firmware (for example, logic encoded in a non-volatile memory that is invoked for operation on a processor as required). The present invention contemplates the substitution of one implementation of hardware, firmware and software for another implementation of the equivalent functionality using a different one of hardware, firmware and software. To the extent that an implementation can be represented mathematically by a transfer function, that is, a specified response is generated at an output terminal for a specific excitation applied to an input terminal of a “black box” exhibiting the transfer function, any implementation of the transfer function, including any combination of hardware, firmware and software implementations of portions or segments of the transfer function, is contemplated herein, so long as at least some of the implementation is performed in hardware.

### Theoretical Discussion

Although the theoretical description given herein is thought to be correct, the operation of the devices described and claimed herein does not depend upon the accuracy or validity of the theoretical description. That is, later theoretical developments that may explain the observed results on a basis different from the theory presented herein will not detract from the inventions described herein.

### INCORPORATION BY REFERENCE

Any patent, patent application, patent application publication, journal article, book, published paper, or other publicly available material identified in the specification is hereby incorporated by reference herein in its entirety. Any material, or portion thereof, that is said to be incorporated by reference herein, but which conflicts with existing definitions, statements, or other disclosure material explicitly set forth herein is only incorporated to the extent that no conflict arises between that incorporated material and the present disclosure material. In the event of a conflict, the conflict is to be resolved in favor of the present disclosure as the preferred disclosure.

While the present invention has been particularly shown and described with reference to the preferred mode as illustrated in the drawing, it will be understood by one skilled in the art that various changes in detail may be affected therein without departing from the spirit and scope of the invention as defined by the claims.

What is claimed is:

1. A kit for playing a game, comprising:
a flag-proportioned base upon which one or more visual elements may be disposed;
at least one visual element comprising a portion of a flag; and
a set of rules for playing said game.

2. The kit for playing a game of claim 1, wherein said at least one visual element is provided on a substrate.

3. The kit for playing a game of claim 2, further comprising a substance configured to allow said at least one visual element to be affixed to said flag-proportioned base.

4. The kit for playing a game of claim 1, wherein said at least one visual element is provided in digital form suitable for use in a general purpose programmable computer.
